(19) United States
(12) Patent Application Publication
(10) Pub. No.: US 2011/0123304 A1
(43) Pub. Date: May 26, 2011

(54) ADJUSTABLE WINCH ASSEMBLY AND SYSTEM FOR LOADING OR UNLOADING VEHICLES ONTO OR FROM A RAISED BED OR DECK

(76) Inventors: Donald Dale Thomas, Sarasota, FL (US); Tori Katherine Thomas, Sarasota, FL (US)

(21) Appl. No.: 12/623,107

(22) Filed: Nov. 20, 2009

(51) Int. Cl. B60P 3/07; B66D 1/00; B60P 1/43; B66D 1/28

(52) U.S. Cl. 414/538; 254/323; 414/812

(57) ABSTRACT

A laterally adjustable winch assembly for loading and unloading an associated vehicle onto or from a raised deck of an associated carrier is disclosed. The laterally adjustable winch assembly includes a first support member and a second support member slideably engaged with the first support member. The second support member includes a first attachment end and a second attachment end. The first and second attachment ends are configured to be detachably secured to a portion of the associated carrier. A retaining member is disposed between the first and second support members for selectively retaining the first support member in fixed relationship with the second support member. A winch is secured to the first support member. The winch includes a retractable winch line capable of being secured to the associated vehicle for winching the associated vehicle from a first level to a second raised level of the deck of the associated carrier. The first and second support members and the retaining member cooperate to allow the winch and winch line to be laterally adjusted with respect to the deck of the associated carrier so as to permit loading and unloading of the associated vehicle in a plurality of lateral positions. A system and method for loading and unloading are also provided.

### BACKGROUND

The present disclosure relates to loading devices and systems for loading or unloading vehicles onto or from a raised bed of a carrier or transport vehicle. The present disclosure also relates to loading systems particularly suited to the loading of multiple vehicles to be transported.

Various prior art devices and methods exist for loading a vehicle to be transported onto a raised bed, deck, or platform. These devices and methods can consist of simply a ramp wherein the operator drives or pushes the vehicle to be transported onto the raised bed. Naturally, such drive-on/off arrangements can be labor intensive, hazardous to the health and safety of the operator, and relies heavily on the operator's driving ability. Specifically such arrangements require the operator to quickly accelerate (i.e., get a running start) up the ramp and timely decelerate the vehicle to be transported prior to colliding with any other structure this is on or part of the transport vehicle or unit (e.g., trailer or truck bed, etc.). Adverse weather conditions (e.g., rain, snow, sleet, ice, etc.) make this task even more precarious.

Still other loading systems may utilize a ramp in combination with an assist device such as a winch for pulling the vehicle to be transported up the ramp or inclined surface and onto the raised bed or platform. Such systems are implemented for a variety of reasons but primarily involve enabling an operator to more comfortably, safely, and easily load a vehicle onto the raised bed. However, these prior art loading systems involve a custom or unique installation for a particular transport vehicle or unit and typically involve a number of parts or components (e.g., multiple track sections, winch units, guides, and other fixtures) that must be carried along with the transport vehicle in order to effectively load and offload the subject vehicle. In many cases, the components of the prior art loading system (i.e., tracks, guides, attachment fixtures, winches, etc.) are fixed or rigidly attached to the transport vehicle rendering this portion of the transport vehicle unusable for other purpose when the subject vehicle to be transported is not in the loaded configuration. For example, some RVs and other transport vehicles include a garage portion for carrying additional cargo such as secondary or recreational vehicles (e.g., motorcycles, ATVs, etc). When these “garages” are not being used to transport cargo they can be used as an additional living space for sleeping, entertaining guests, tailgating, etc. As mentioned previously, the prior art loading systems are not suited for such multi-purpose spaces since their fixtures remain in place both during and after the subject vehicle has been transported making it difficult to navigate around such fixtures (which present trip hazards), arrange furniture/bedding, lay carpets, or otherwise make alternate use of this space.

Moreover, the prior art loading systems make it difficult, if not impossible, to safely load and transport more than one wheeled vehicle onto the transport vehicle in an adjacent or side-by-side configuration and/or end-to-end configuration. Because transport vehicles or units are of limited width (due to road constraints and/or vehicle regulations) this affords only a minimal amount of “cushion” or dead space between the adjacent vehicles that are already loaded or are to be loaded. In such cases, it is common for a winch line to either interfere with a vehicle that is already loaded or for the operator to inadvertently scrape or otherwise damage an adjacent loaded vehicle with the one currently being loaded.

For these reasons and others discussed below, a need exists for an improved system for loading and unloading vehicles onto and from a raised bed, trailer, or other vehicle carrier or transport unit.

### SUMMARY

According to one aspect of the present disclosure, a laterally adjustable winch assembly for loading and unloading an associated vehicle onto or from a raised deck of an associated carrier is provided. The laterally adjustable winch assembly includes a first support member and a second support member slideably engaged with the first support member. The second support member includes a first attachment end and a second attachment end. The first and second attachment ends are configured to be detachably secured to a portion of the associated carrier. A retaining member is disposed between the first and second support members for selectively retaining the first support member in fixed relationship with the second support member. A winch is secured to the first support member. The winch includes a retractable winch line capable of being secured to the associated vehicle for winching the associated vehicle from a first level to a second raised level of the deck of the associated carrier. The first and second support members and the retaining member cooperate to allow the winch and winch line to be laterally adjusted with respect to the deck of the associated carrier so as to permit loading and unloading of the associated vehicle in a plurality of lateral positions.

According to another aspect of the present disclosure, a raised bed loading and unloading system for assisting an operator in moving an associated vehicle to be transported between a first elevation and a higher second elevation is provided. The system includes a transport unit having a bed at the higher second elevation. The bed is capable of transporting the associated vehicle and includes a longitudinal axis and a transverse axis. The longitudinal axis of the bed is oriented generally parallel to the direction of loading and off loading. A first track is secured to and extends longitudinally along a first side of the bed. A second track is secured to and extends longitudinally along a second side of the bed. A laterally adjustable winch assembly includes a winch slidably secured to a winch support member. The support member is removably secured to the first and second tracks and the winch is capable of being selectively positioned laterally along the support member between the first and second tracks. The winch can be laterally adjusted with respect to the bed of the transport unit to enable the operator of the system to load and off load the associated vehicle in a plurality of lateral positions between the first and second elevations.

According to still another aspect of the present disclosure, a method for loading a vehicle to be transported onto a raised deck of a carrier vehicle is provided. A laterally adjustable winch assembly is provided including a winch slidably secured to a winch support member. The support member is attached to the deck of the associated carrier vehicle such that the support member extends transversely across the deck relative to a longitudinal axis of the associated carrier vehicle. The lateral position of the winch is adjusted along the support member. The winch is secured to the support member such that the winch is fixed relative to the support member. A winch line of the winch is dispensed. The winch line is attached to a portion of the associated vehicle to be transported. The winch line is retracted and simultaneously the associated vehicle to be transported is pulled onto the raised deck of the associated carrier vehicle.

### BRIEF DESCRIPTION OF THE DRAWINGS

FIG. 1A is a perspective view of a first embodiment of a raised bed loading and unloading system including an adjustable winch assembly tethered to an associated vehicle to be loaded and transported.

FIG. 1B is a perspective view of the system and adjustable winch assembly of FIG. 1 now illustrating the associated vehicle to be transported in a partially-loaded state.

FIG. 1C is a perspective view of the system and adjustable winch assembly of FIG. 1A now illustrating the associated vehicle to be transported in a fully-loaded state.

FIG. 2 is a top view of the adjustable winch assembly of FIG. 1A.

FIG. 3 is an enlarged top view of the adjustable winch assembly of FIG. 2.

FIG. 4 is an enlarged side view of one end of the adjustable winch assembly of FIG. 3 illustrating the quick release latch and channel.

### DETAILED DESCRIPTION

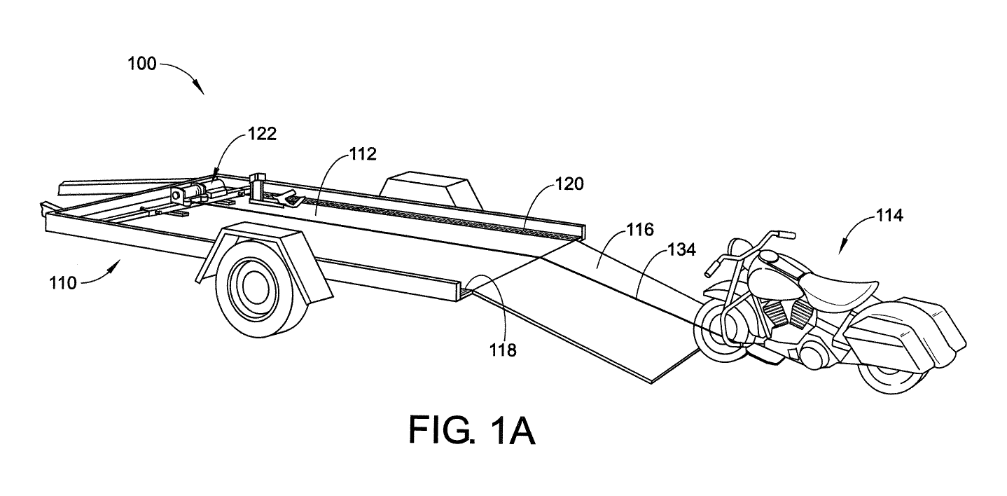

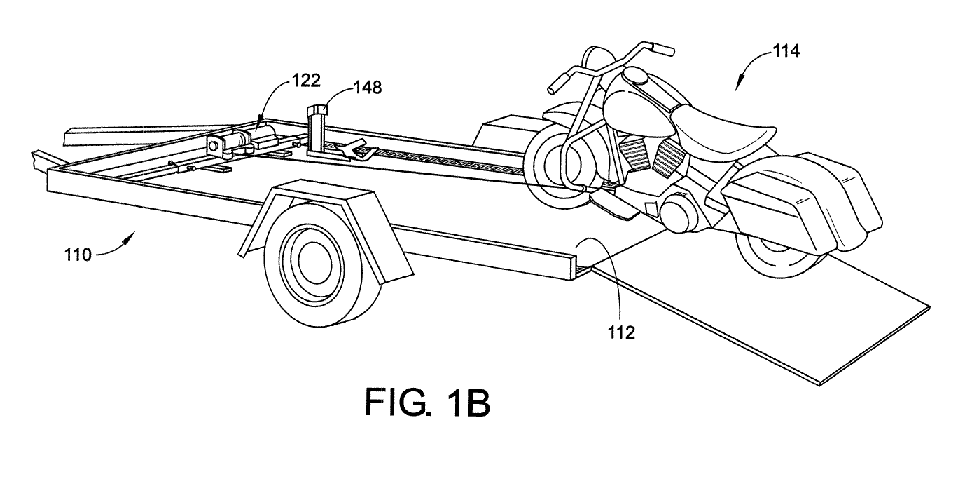

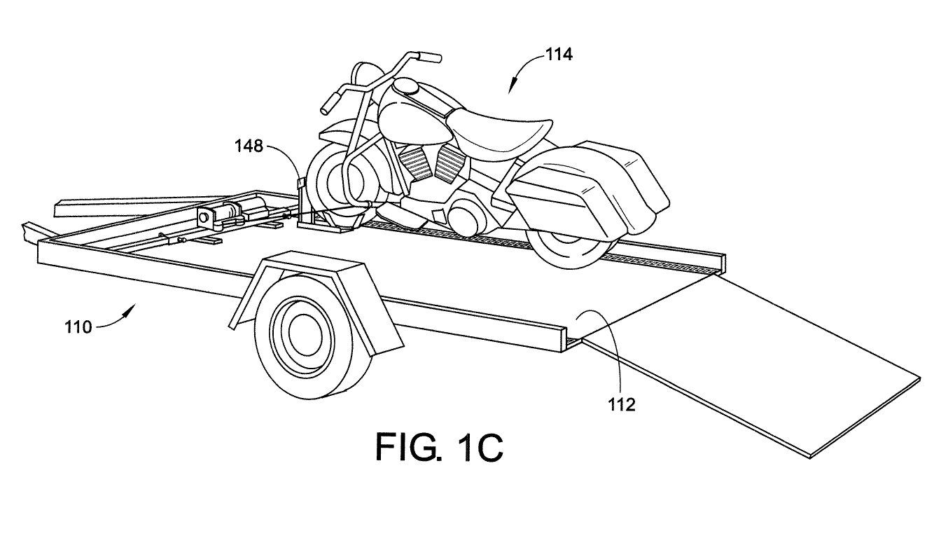

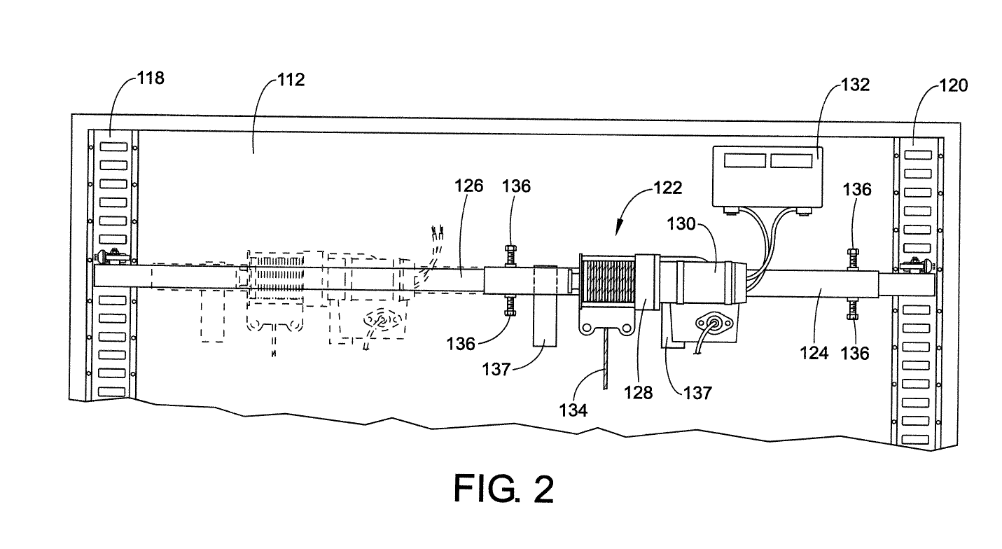

With reference to FIGS. 1A and 2, a raised bed loading and unloading system 100 is shown. The system 100 generally includes a transport unit or carrier vehicle 110 having a raised bed or deck 112 capable of supporting the weight of a vehicle to be transported such as a motorcycle 114 as shown in FIG. 1A.

While the Figures illustrate the vehicle to be transported as being a motorcycle, it should be noted that the present invention can be used to load and unload various types of vehicles. The term vehicle as used herein, is intended to include and not be limited to, any wheeled vehicle, such as motorcycles, ATVs, golf carts, lawn and garden equipment, construction equipment, etc. and any non-wheeled vehicle, such as snowmobiles or other track driven devices, boats, jet skis, or other water craft, etc. Similarly, the terms transport vehicle, transport unit, and carrier are intended to include, but are not intended to be limited to, open trailers, closed trailers, pickup trucks, box trucks, motor homes, RVs, fifth wheel toy haulers, or any vehicle having a raised bed, deck, platform, garage, compartment, cargo hold, or housing capable of supporting and/or transporting a vehicle.

With continued reference to FIGS. 1A and 2, and in the instant example, the transport vehicle 110 is an open-type trailer which includes a ramp 116 and a pair of longitudinally-extending tracks or channels 118, 120. In addition, the system 100 includes an adjustable winch assembly 122 which can be secured to the trailer 110 via the tracks 118, 120. With reference to FIG. 2, the adjustable winch assembly 122 is shown in greater detail.

The adjustable winch assembly 122 generally includes a first support member 124 and a second support member 126. The second support member 126 can be slidably engaged with the first support member 124. In addition, the first support member 124 may provide a base for a winch 128 to be secured thereon. The winch 128 may be driven by a winch motor 130 powered by an onboard power supply 132 such as a 12-volt automotive battery. Alternately, the winch could be manually driven. The winch 128 and the first support member 124 can be slidably adjusted in a lateral or transverse direction along the length of the second support member 126 so as to properly align the winch line 134 of the winch 128 in order to best facilitate the loading (or unloading) and the final positioning of the vehicle to be transported.

By way of example, the winch 128 and first support member 124 are depicted in a first or right-hand configuration in FIG. 2. In such a configuration, the vehicle to be loaded or transported would naturally assume or come to rest near the right-hand side of the deck 112. Similarly, if the winch 128 and the first support 124 were to be slidably and laterally repositioned or adjusted such that the winch 128 and the first support member 124 were placed at a second or left-hand configuration (as shown in phantom lines), the vehicle to be loaded would naturally assume or come to rest at a left-hand orientation or position on the deck 112. Thus, the slideably engaged support members 124 and 126 easily and efficiently provide for safe and optimal loading of multiple vehicles particularly when the space between such adjacently configured vehicles is limited.

It should also be noted that when the winch 128 and first support 124 are positioned, as desired, along the second support member 126, one or more retaining members 136 can be used to fix the first support member 124 with respect to the second support member 126 preventing any unwanted lateral movement during loading and offloading of the vehicle to be transported. While FIG. 2 illustrates the retaining members 136 as threaded fasteners which are used to pinch or clamp the two support members together, it should also be noted that other techniques for preventing relative movement between the first and second support members 124, 126 could be used. For example, through pins, clevis pins, cotter pins, pushbutton detents or similar locking projections in one support member can be configured to align with corresponding apertures in the other support member. Alternately, grooves, notches, tabs, pins, teeth, or any other detent technique for locking or otherwise latching the laterally adjustable support members together could be used.

In addition, the slideably engaged first and second support members could take the form of two or more telescopic members arranged in a concentric or stacked configuration such that extension of a first or inner most member beyond a predetermined point will cause the second and subsequent members to be extended also. Moreover, it should further be noted that the second support member 126 could itself be made up of more than one piece such that a first or left-hand portion of the second support member 126 can be separate from a second or right-hand portion of the second support member. This would allow the left and right hand portions of the second support member to be independently adjusted with respect to the first support member 124. Such independent adjustment would allow the adjustable winch assembly to be used on a wide range of transport vehicles even if the spacing between the first and second tracks 118, 120 is different.

Also, as best illustrated in FIGS. 2-4, the winch assembly may include one or more anti-rotation members or stabilizer arms 137. In general, the arms 137 can be attached to any portion of the winch assembly (e.g., winch housing, support members, attachment points, etc.) and can be oriented in any manner that will provide additional support to the winch assembly 122 during operation. In the instant embodiment, and by way of example only, a pair of stabilizer arms 137 are attached to a bottom surface of the first support member 124 on either side of the winch line 134. In addition, the stabilizer arms may rest on or otherwise engage the deck of the transport vehicle and extend in the direction of the winch line (e.g., towards the ramp or loading end of the trailer). The primary purpose of the stabilizer arms is to prevent excessive rotation of the winch assembly during operation of the winch assembly or when the winch is otherwise under load. In certain instances, the loads may be so great that the winch assembly may be more susceptible to “pull out” or disengagement from the tracks or deck of the transport vehicle. By using one or more stabilizer arms, any rotational force or “moment arm” that may be generated by the load will be directed into the deck by way of the stabilizer arms thereby preventing premature disengagement and/or damage to the winch assembly. It should be noted that the arms could also be pivotally attached to the winch assembly, such that the arms can be folded away or back against the support members to make handling and transportation of the winch assembly easier.

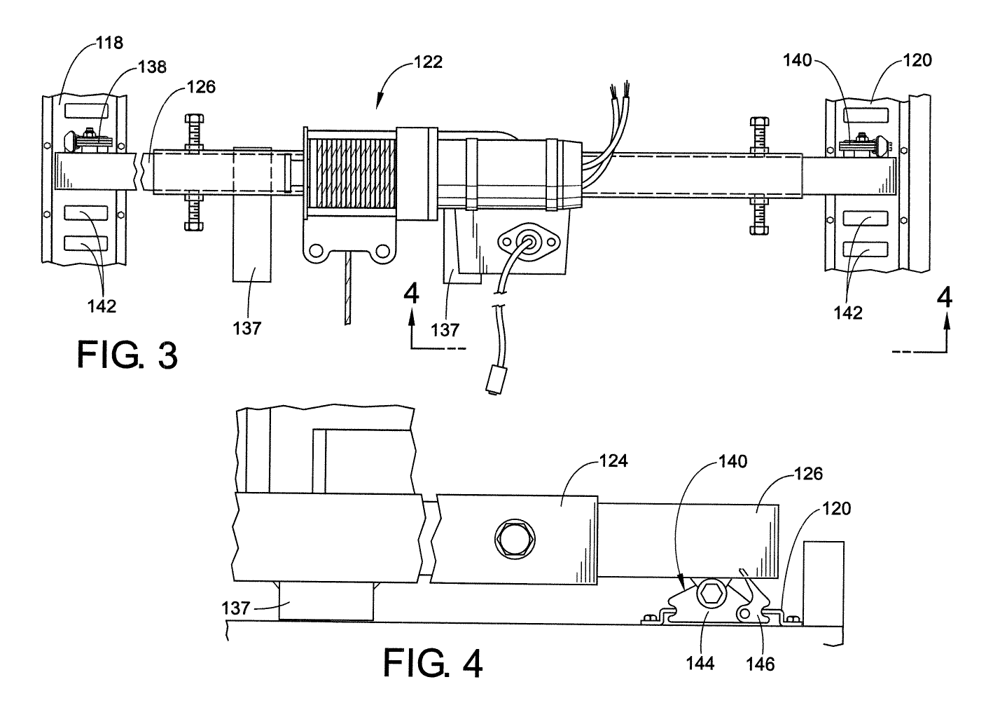

Now with reference to FIG. 3, an enlarged view of the adjustable winch assembly 122 is shown (with a section of the second support member 126 illustrated as broken away). In particular, the winch assembly 122 of FIG. 3 better illustrates the use of a first and second quick release latching members 138, 140 for securing the respective ends of the second support member 126 to the first and second track or channel members 118, 120. As is illustrated, track members 118, 120 (also known as E-channels) include a plurality of apertures 142 for receiving the latching members 138, 140 as is best illustrated in FIG. 4. As shown in FIG. 4, the right-hand side latching member 140 (which is also representative of the left-hand side latching member 138) includes a base portion 144 which is pivotally attached to the second support member 126. In addition the latching member 140 includes a quick release lever 146 which, when pried upward or outward, effectively detaches or releases the latching member 140 from the track 120. While the figures herein depict the use of E-Channels as the attachment point for the adjustable winch assembly, it should be appreciated that it is possible to use other attachment devices such as snaps, hooks, quick release loops or links, D-rings, or any other fastener or attachment fixture capable of withstanding the loads exerted by the winch assembly during operation.

With reference to FIGS. 1A-1C, one method for loading the wheeled vehicle to be transported onto the raised deck or bed of a trailer or other transport vehicle is illustrated. In general, the adjustable winch assembly 122 is first adjusted for overall width to match the width of the track members 118, 120. The assembly is then latched or otherwise attached to the track members, channels, or other attachment fixture provided at the desired longitudinal position along the deck.

Next, the winch portion of the assembly can be adjusted laterally so as to best align the winch line of the winch with the intended final lateral position of the vehicle to be loaded and transported. The winch and the laterally adjustable support members are then fixed together by way of the retaining members (e.g., the threaded fasteners) so as to place the support members in a fixed relationship and to prevent any undesired lateral movement. The power supply can then be connected to the winch motor which may also included a remote switch for starting and stopping the winch.

As shown in FIG. 1A, the winch line is then dispensed or let out and attached to the vehicle to be transported (e.g., motorcycle 114) which is at a first elevation or ground level. The winch line can be attached to any portion of the vehicle to be transported (e.g., the motorcycle's frame) that will preferably not interfere with the winch line as the vehicle is winched up the ramp 116 and onto the bed 112. In some cases, and particularly those involving two wheeled vehicles, the operator may desire to guide or direct the vehicle to be transported up the ramp and onto the raised bed or deck while the winch is retracting the winch line. This allows the operator to make fine laterally adjustments and to ensure damage to nearby structures or the vehicle itself is avoided. In addition, it may be preferred to add a guard, a skid plate, or roller at or near a rearward edge of the bed or deck of the transport unit for slideably or otherwise engaging the winch line to prevent damage to either of the transport unit or the winch line itself.

With reference to FIG. 1B, the motorcycle 114 is shown as being partially loaded onto the deck 112 of the trailer 110. Typically, the deck or bed of the transport unit is at a higher second elevation as compared to initial or first elevation of the vehicle (which is usually ground level) and must be winched up onto the deck or bed. With continued reference to FIG. 1B, it is noted that the winch assembly 122 is illustrated in the right-hand most configuration. As such, this allows a front wheel of the motorcycle 114 to be aligned with a wheel cradle 148 that is also oriented on the right side of the illustrated arrangement. The wheel cradle 148 or any chuck or stop or the winch assembly itself could be equipped with a limit switch, an optical sensor, a pressure sensor or other sensor for determining when the vehicle to be loaded has reached its final or loaded position and for powering down any electrically driven winch assembly. As such, the operator may engage the powered winch assembly and assist in guiding the vehicle to be loaded without concern to any damage to the vehicle being transported or the winch assembly due to over loading of the system, etc. Furthermore, the winch assembly may include a wireless transmitter/receiver system for remotely activating and deactivating the winch assembly. For example, a wireless transmitter (e.g., an RF or IR based key fob, hand-held remote, etc.) could be used by the operator when loading the vehicle to be transported in starting, stopping, or reversing the winch all while the operator is standing nearby, supporting, or otherwise guiding the vehicle to be transported as it is being loaded onto or unloaded from the transport vehicle.

With reference to FIG. 1C, the motorcycle 114 is now illustrated as being fully loaded onto the deck 112 of the trailer 110 and the front wheel of the motorcycle has been fully received into the wheel cradle 148. At this point, the winch line can be disconnected from the vehicle being transported and the winch assembly can be readjusted and used to load another vehicle, detached from the track channel and stowed away, or it can be left in the installed configuration while the vehicle is being transported.

It should be noted that another advantage of the instant invention is that the adjustable winch assembly can be used to load and off load vehicle not only in various lateral positions (i.e, side-by-side) on the transport vehicle but also in an end-to-end configuration (i.e., longitudinally along the length of the transport vehicle). As soon as the first vehicle or set of vehicles is loaded, the adjustable winch assembly can be repositioned just aft of the first vehicle(s), reattached to the deck or bed and used to load another set of vehicles. This procedure can be further simplified when E-channels or similar track fixtures are mounted lengthwise along the deck or bed since they provide a plurality of apertures or attachment points which allow the winch assembly to be attached anywhere along the length of the track or channel.

Laslt, unloading or off loading of the vehicle can be done by reversing the procedure set forth above. Alternatively, the vehicle can be off loaded by simply detaching the vehicle from any supports on the transport unit and rolling the vehicle down or off the transport unit. In some cases, as for example, where the vehicle being transported is heavy, cumbersome, delicate, non-functional, etc. it may be advantageous to use the present invention to slowly lower the vehicle down from or off of the transport unit.

An adjustable winch assembly and system for loading and unloading vehicles onto or from a raised bed or trailer have been described with reference to particular embodiments. Modifications and alterations will occur to those upon reading and understanding the preceding detailed description. The invention is not limited to only those embodiments described above. Instead, the invention is broadly defined by the appended claims and the equivalents thereof.

1. A laterally adjustable winch assembly for loading and unloading an associated vehicle onto or from a raised deck of an associated carrier, the winch assembly comprising:
a first support member;
a second support member slideably engaged with the first support member, the second support member having a first attachment end and a second attachment end, the first and second attachment ends being configured to be detachably secured to a portion of the associated carrier;
a retaining member disposed between the first and second support members for selectively retaining the first support member in fixed relationship with the second support member;
a winch secured to the first support member, the winch including a retractable winch line capable of being secured to the associated vehicle for winching the associated vehicle from a first level to a second raised level of the deck of the associated carrier; and
wherein the first and second support members and the retaining member cooperate to allow the winch and winch line to be laterally adjusted with respect to the deck of the associated carrier so as to permit loading and unloading of the associated vehicle in a plurality of lateral positions.

2. The winch assembly of claim 1, wherein the first and second attachment ends of the second support member each include a quick release latch.

3. The winch assembly of claim 1, wherein the first attachment end of the second support member is separate and independently adjustable from the second attachment end of the second support member.

4. The winch assembly of claim 1, wherein the retaining member includes a threaded fastener for clamping the first support member to the second support member.

5. The winch assembly of claim 1, wherein one of the first support member or the second support member includes a plurality of detents and the other of the first support member or the second support member includes a tab for selectively engaging one of the plurality of the detents and holding the first and second support members in relative fixed relationship.

6. The winch assembly of claim 1, wherein the first and second support members are telescopically and slideably engaged for adjustably spanning a transverse section of the deck of the associated carrier.

7. The winch assembly of claim 1, further including a stop switch for deactivating the winch when the associated carrier has reached a final loaded position.

8. A raised bed loading and unloading system for assisting an operator in moving an associated vehicle to be transported between a first elevation and a higher second elevation, the system comprising:
a transport unit having a bed at the higher second elevation, the bed capable of transporting the associated vehicle and including a longitudinal axis and a transverse axis, the longitudinal axis of the bed oriented generally parallel to the direction of loading and off loading;
a first track secured to and extending longitudinally along a first side of the bed;
a second track secured to and extending longitudinally along a second side of the bed;
a laterally adjustable winch assembly including a winch slidably secured to a winch support member, the support member being removably secured to the first and second tracks, the winch capable of being selectively positioned laterally along the support member between the first and second tracks; and
wherein the winch can be laterally adjusted with respect to the bed of the transport unit to enable the operator of the system to load and off load the associated vehicle in a plurality of lateral positions between the first and second elevations.

9. The system of claim 8, wherein the first and second tracks include a plurality of apertures.

10. The system of claim 9, wherein the support member of the winch assembly includes a first and second quick release member for selectively engaging the plurality of apertures in the respective first and second tracks.

11. The system of claim 8, wherein a first attachment end of the second support member is separate and independently adjustable from a second attachment end of the second support member.

12. The system of claim 8, further including a retaining member for securing the winch to the support member in relative fixed relationship.

13. The system of claim 8, wherein the support member is telescopic and slideably engages the winch for transversely spanning a section of the bed of the associated transport unit in a plurality of lateral positions.

14. The system of claim 8, further including a stop switch for deactivating the winch when the associated vehicle has reached a final loaded position.

15. The system of claim 8, further including a guard disposed at a rearward edge of the bed for slideably engaging a winch line of the winch.

16. The system of claim 8, wherein the winch assembly further includes one or more stabilizer arms for limiting rotation of the winch assembly when the winch assembly is in use.

17. The system of claim 8, further including a wireless transmitter and receiver for selectively activating and deactivating the winch of the winch assembly.

18. A method for loading a vehicle to be transported onto a raised deck of a carrier vehicle, comprising:
providing a laterally adjustable winch assembly including a winch slidably secured to a winch support member;
attaching the support member to the deck of the associated carrier vehicle such that the support member extends transversely across the deck relative to a longitudinal axis of the associated carrier vehicle;
adjusting the lateral position of the winch along the support member;
securing the winch to the support member such that the winch is fixed relative to the support member;
dispensing a winch line of the winch;
attaching the winch line to a portion of the associated vehicle to be transported; and
retracting the winch line and simultaneously pulling the associated vehicle to be transported onto the raised deck of the associated carrier vehicle.

19. The method of claim 18, wherein providing the winch assembly further includes providing a first and second quick release latch disposed on opposite ends of the support member of the winch assembly and providing a first and second longitudinally extending e-channels on the deck of the carrier vehicle.

20. The method of claim 19, wherein attaching the support member includes depressing the first latch into an aperture of the first e-channel and subsequently depressing the second latch into an aperture of the second e-channel.

21. The method of claim 20, wherein retracting the winch line and pulling the associated vehicle to be transported further includes guiding the associated vehicle into a final loaded position.

22. The method of claim 21, further includes deactivating the winch when the associated vehicle has reached the final loaded position.
